(19) United States
(12) Patent Application Publication
(10) Pub. No.: US 2024/0386167 A1
(43) Pub. Date: Nov. 21, 2024

(54) MODELING METHOD FOR ENERGY STORAGE TANK EXPLOSION VENTING TO PREVENT THERMAL RUNAWAY GAS EXPLOSION IN LITHIUM-ION BATTERIES

(71) Applicant: CHINA UNIVERSITY OF PETROLEUM (east CHINA), Qingdao (CN)

(72) Inventors: Depeng KONG, Qingdao (CN); Rongqi PENG, Qingdao (CN); Ping PING, Qingdao (CN)

(73) Assignee: CHINA UNIVERSITY OF PETROLEUM (east CHINA), Qingdao (CN)

(21) Appl. No.: 18/334,721

(22) Filed: Jun. 14, 2023

(30) Foreign Application Priority Data
May 12, 2023 (CN) 2023105349639

(51) Int. Cl. G06F 30/27

(52) U.S. Cl. CPC G06F 30/27; G06F 2111/10; G06F 2113/08

(57) ABSTRACT

The invention discloses a modeling method for energy storage tank explosion venting to prevent thermal runaway gas explosion in lithium-ion batteries, which relates to the technical field of lithium-ion battery energy storage tank design, including the following steps: 1. Determine lithium-ion battery type to obtain component classification and ratio of mixed gas produced after thermal runaway; 2. Calculate laminar burning velocity of mixed gas and thermophysical parameters using FreeFlam 1D combustion model; 3. Set coupling boundary of venting plate, divide premixed area inside the tank and the air area outside the tank, establish geometric modeling and grid of battery energy storage tank, and establish three-dimensional combustion process equation according to the boundary conditions; 4. Solve three-dimensional combustion process equation to obtain the evolution characteristics of overpressure, temperature, and wind speed in the internal and external flow fields of energy storage tank.

### CROSS-REFERENCE TO RELATED APPLICATIONS

The application claims priority to Chinese patent application No. 2023105349639, filed on May 12, 2023, the entire contents of which are incorporated herein by reference.

### TECHNICAL FIELD

This invention relates to the technical field of lithium-ion energy storage tank design, in particular to a modeling method for energy storage tank explosion venting to prevent thermal runaway gas explosion in lithium-ion batteries.

### BACKGROUND

With the implementation of “Dual Carbon (carbon peaking and carbon neutrality)” strategy in China, photovoltaic energy, wind energy, tidal energy and other renewable energy sources have developed rapidly in China. However, the fluctuation of these renewable energies may cause impacts on the distribution network after being directly connected to the grid. The solution is to introduce energy storage systems. The power generation side stores electricity in the energy storage system, and the grid performs peak load shaving, frequency regulation, voltage regulation, etc. according to the demand of the user side, thereby improving power quality and the convergence ability of distributed renewable energy. Lithium-ion battery is widely used in energy storage field because of its high energy density, low self-discharge rate, long service life and flexible response. However, lithium-ion batteries contain flammable organic electrolytes and temperature sensitive electrode materials, which can cause irreversible thermal runaway when exposed to abnormal conditions. During this process, the lithium-ion battery releases thermal energy and sprays a large amount of gas such as hydrogen, carbon monoxide, carbon dioxide, and alkanes through the ruptured safety valve. Considering that there are thousands of battery units and other electrical components installed inside the energy storage tank, in the event of battery thermal runaway, the generated heat will quickly transfer to adjacent batteries, causing thermal runaway to spread. At the same time, these thermal runaway batteries will discharge a large amount of mixed gas into the internal space of the energy storage tank. Once mixed with air, the gases will be ignited by jet fires triggered by thermal runaway or sparks from other electrical equipment, or when the temperature reaches the ignition point, it will cause gas explosions, and the generated shock wave overpressure and high-temperature flames will be released outward through the energy storage tank door, triggering external disasters. At the same time, the fluidity of the gas causes the combustible mixture in the tank to be rapidly discharged at the moment of opening the energy storage tank door, and forms a gas cloud near the door. When the explosion flame spreads outside the door, it will ignite the gas cloud, triggering an external explosion and causing a second injury to nearby personnel and buildings. Although there have been front-end studies on energy storage tank level to avoid such accidents, including but not limited to the design of active ventilation systems in tanks, the establishment of combustible gas warning systems, and other related measures. But once these measures fail for some reason, explosions caused by the thermal runaway emissions of lithium-ion batteries will inevitably occur. Therefore, the explosion venting design of energy storage tanks serves as the final step in risk prevention and control. Once the pressure inside the tank exceeds the threshold, the activated explosion venting device will induce gas explosions in an open pre-set safety area instead of the energy storage tank or a threat area to surrounding personnel and facilities, thereby reducing the risk and disaster of gas explosion accidents. Studying the explosion venting of energy storage tanks in the event of thermal runaway gas explosions in lithium-ion batteries can help reveal the laws of the explosion venting flow field and enhance the prevention and control capabilities of gas explosion accidents in energy storage tanks. This is of great significance for the safety design of energy storage systems and the development of accident risk prevention and control measures.

Given the high difficulty and low safety of explosion venting experiments in energy storage tanks, numerical simulation method, not limited by time, space, and parameter measurement strategies, can comprehensively predict shock waves, high-temperature flames, hurricane fields, and other effects of thermal runaway gas explosions in lithium-ion batteries, making them a powerful tool for studying the safety design of explosion venting in energy storage tanks. At present, the main method is to simulate the equivalent gas of mixed combustible gas of lithium-ion battery based on the fixed database of commercial software, and then calculate the disaster behavior of gas explosion in the energy storage tank. In fact, different lithium-ion batteries with different electrode materials have different compositions of mixed gases emitted after thermal runaway, and the proportions of each gas component differ due to changes in the charge state, leading to differences in the laminar burning velocity and thermophysical properties of the mixed gases. The equivalent gas model blurs this fact, resulting in larger differences between the predicted and actual explosion values. And the equivalent gas often does not consider the inhibitory effect of inert gases such as carbon dioxide in the mixed gas on the gas explosion characteristics.

In summary, existing technology makes it difficult to accurately assess the disaster characteristics of gas explosions caused by actual emissions from lithium-ion battery thermal runaway, which in turn restricts the explosion venting safety design of energy storage tank.

### SUMMARY

To meet the actual needs in the field of lithium-ion battery energy storage tank design, the invention overcomes the shortcomings of existing technologies and aims to solve the technical problem by providing a modeling method for energy storage tank explosion venting to prevent thermal runaway gas explosion in lithium-ion batteries, and assess the risk of safety design of energy storage tank explosion venting.

To solve the above technical problem, the technical solution adopted by the invention is a modeling method for energy storage tank explosion venting to prevent thermal runaway gas explosion in lithium-ion batteries, comprising the following steps:

Step 1: Determine the type of lithium-ion battery and obtain the classification and proportion of the mixed gas produced after thermal runaway:

Step 2: Based on the actual proportion of the mixed gas obtained in Step 1, import the FreeFlame one-dimensional combustion model to calculate the laminar burning velocity of the mixed gas, and calculate the thermophysical parameters at the same time:

Step 3: Set the coupling boundary of the explosion venting plate, divide the premixed area in the tank and the air area outside the tank, establish the geometric modeling and grid of the battery energy storage tank, and establish the three-dimensional combustion process equation according to the boundary conditions:

Step 4: Take the laminar burning velocity and thermophysical parameters of the mixed gas obtained in Step 2 as inputs to solve the three-dimensional combustion process equation, and obtain the evolution characteristics of overpressure, temperature, and wind speed of the internal and external flow fields of the energy storage tank under the explosion venting design, and complete the risk assessment of the explosion venting design of the energy storage tank.

Preferably, in Step 2, the calculation formula for laminar burning velocity is:

$${S}_{L} ( ϕ , T , p ) = {ωϕ}^{n} {e}^{ξ ( ϕ - 1.075 )} \cdot {( \frac{T}{{T}_{ref}} )}^{α} \cdot {( \frac{p}{{p}_{ref}} )}^{β} \cdot ( 1 - {X}_{f} \cdot f ) ;$$

Where, S_{L} is the laminar burning velocity, φ is the air equivalence ratio of the mixed gas, T is the temperature and p is the pressure, ω, η, ξ, α, β and f are Gülder coefficients, T_{ref} is the reference temperature, p_{ref} is the reference pressure, and X_{f} is the molar fraction of the inert gas;
The Gülder coefficient is obtained by solving steady-state solutions for one-dimensional free propagation, planar, and adiabatic flames.

Preferably, the calculation method for the Gülder coefficient is:
Calculate the values of S_{L} (φ), S_{L}(P) and S_{L}(T) through the control equation of a one-dimensional combustion model;
Fit the curve fitting equations of S_{L} (φ), S_{L}(P) and S_{L}(T) to obtain the value of the Gülder coefficient. The curve fitting equation is:

$${S}_{L} ( ϕ ) = {ωϕ}^{n} {e}^{ξ ( ϕ - 1.075 )} ;$$

$${S}_{L} ( T ) = {S}_{L} ( ϕ = 1 , {T}_{ref} , {p}_{ref} ) {( \frac{T}{{T}_{ref}} )}^{α} ;$$

$${S}_{L} ( p ) = {S}_{L} ( ϕ = 1 , {T}_{ref} , {p}_{ref} ) {( \frac{p}{{p}_{ref}} )}^{β} .$$

Preferably, in Step 2, the control equation of the one-dimensional combustion model includes:

$$Continuity \text{equation:} \dot{m} = ρ uA = cons ;$$

$$Gas conservation \text{equation:} ρ u \frac{δ {Y}_{i}}{δ x} + \frac{δ {J}_{i}}{δ x} = {\dot{ω}}_{i} {W}_{i} ;$$

$$Energy conservation \text{equation:} ρ {uC}_{p} \frac{δ T}{δ x} = \frac{δ}{δ x} ( λ \frac{δ T}{δ x} ) - {\sum }_{i} {h}_{i} {\dot{ω}}_{i} {W}_{i -} {\sum }_{i} {J}_{i} {C}_{p , i} \frac{δ T}{δ x} ;$$

Where, \dot{m} is the mass flow rate, ρ is density, u is gas flow rate, cons is constant, Yi is mass fraction of gas i, Jᵢ is diffusion mass flux of gas i, x is position, \dot{ω}ᵢ is molar fraction of gas i, Wᵢ is molar weight of gas i; Cₚ is constant pressure specific heat capacity, T is temperature, λ is thermal conductivity, hi is the enthalpy value of gas i, Cₚ, i is the heat capacity of gas i.

Preferably, in Step 2, the thermophysical parameters include air fuel mass ratio, molar weight, molar weighted NASA polynomial coefficients, and Sutherland coefficients. The calculation formula for the air fuel mass ratio is:

$${AFR}_{st} = {( \frac{{m}_{air}}{{m}_{fuel}} )}_{stoic} ;$$

Where, mₐᵢᵣ is air mass, m_{fuel} is the mass of combustible gas mixture, and stoic is the appropriate and complete combustion of the fuel.

The calculation formula for the molar weighted NASA polynomial coefficients is:

$${\overline{a}}_{i} = {\sum }_{i = 0}^{k} {a}_{i , k} {X}_{k} ;$$

Where, i is the polynomial index, k is the component, āᵢ is the coefficient of the index i in the molar weighted polynomial, a_{i, k} is the coefficient of the index i in the polynomial of component k, and Xₖ is the molar fraction of component k.

$${a}_{i} = ( \begin{matrix}{T}_{l} \leq T < {T}_{c} : lowlowCpcoeffs \\ {T}_{c} \leq T \leq {T}_{h} : highCpCoeffs\end{matrix} ;$$

$$\frac{{C}_{p} ( T )}{{R}_{u}} = {a}_{0} + {a}_{1} T + {a}_{2} {T}^{2} + {a}_{3} {T}^{3} + {a}_{4} {T}^{4} ;$$

$$\frac{h ( T )}{{R}_{u}} = {a}_{0} T + \frac{{a}_{1} {T}^{2}}{2} + \frac{{a}_{2} {T}^{3}}{3} + \frac{{a}_{3} {T}^{4}}{4} + \frac{{a}_{4} {T}^{5}}{5} + {a}_{5} ;$$

$$\frac{s ( T )}{{R}_{u}} = {a}_{0} {ln}^{T} + {a}_{1} T + \frac{{a}_{2} {T}^{2}}{2} + \frac{{a}_{3} {T}^{3}}{3} + \frac{{a}_{4} {T}^{4}}{4} + {a}_{6} ;$$

Where, aᵢ is the coefficient of the index i in the polynomial, Cₚ is the constant pressure specific heat capacity, Rᵤ is the general gas constant, h is the enthalpy value, s is the entropy value, T is the temperature, a₀ is the polynomial coefficient velocity vector, and a₁, a₂, a₃, a₄, a₅ and a₆ are polynomial coefficients;

The calculation formula for Sutherland coefficient is:

$$μ = \frac{{A}_{s} \sqrt{T}}{1 + \frac{{T}_{s}}{T}} ;$$

Where, μ is the dynamic gas viscosity, Aₛ and Tₛ are the Sutherland coefficients, and T is the temperature.

Preferably, in Step 3, the three-dimensional combustion process equation is:

$$\frac{\partial ( ρ b )}{\partial t} + \frac{\partial ( ρ {\tilde{u}}_{i} b )}{\partial {x}_{i}} = \frac{\partial }{\partial {x}_{i}} ( \frac{{μ}_{t}}{{Sc}_{t}} \cdot \frac{\partial b}{\partial {x}_{i}} ) - {\dot{ω}}_{b} ;$$

Where, ρ is density, b is the combustion regression variable, ũᵢ is the velocity vector, μₜ is the dynamic viscosity under turbulent state, Scₜ is the turbulent Schmidt number, t is time, xᵢ is displacement: \dot{ω}_{b·} is the source term of reaction rate, and the calculation formula is:

$${\dot{ω}}_{b \cdot } = {ρ}_{u} {S}_{u} Ξ \vert ∇ b \vert .$$

Preferably, in Step 3, the control equation for the physical parameters in the three-dimensional combustion model includes:

Surface filtration strain rate control equation, turbulence generation rate control equation, turbulence removal rate control equation, and decomposition strain rate control equation:

The control equation for surface filtration strain rate is:

$${σ}_{s} = \frac{∇ \cdot {U}_{s} - \hat{n} \cdot ( ∇ {U}_{s} ) \cdot \hat{n}}{Ξ} + \frac{( Ξ + 1 ) ( ∇ \cdot ( {S}_{u} \hat{n} ) - \hat{n} \cdot ( ∇ \cdot ( {S}_{u} \hat{n} ) ) \cdot \hat{n} )}{2 Ξ} ;$$

Where, σₛ is the surface filtration strain rate, Us is the flame surface filtration rate, \hat{n} is the strain rate in the propagation direction, Ξ is the flame subgrid fold factor;

The decomposition strain rate control equation is:

$${σ}_{t} = ∇ \cdot ( {U}_{s} + {S}_{u} Ξ \hat{n} ) - \hat{n} \cdot ( ∇ ( {U}_{s} + {S}_{u} Ξ \hat{n} ) ) \cdot \hat{n} ;$$

Where, σₜ is the decomposition strain rate, Su is the laminar flame rate.

Preferably, in Step 4, the specific method for solving the combustion and explosion model of the three-dimensional energy storage tank is:

At the initial state, the coupling boundary is used as the wall state, and then each time step will iterate the surface cell states on both sides of the boundary and calculate the area weighted pressure difference on both sides. The calculation formula is:

$${P}_{diff} = \frac{\sum {P}_{in - face ( i )} \cdot {S}_{in - face ( i )} - \sum {P}_{out - face ( i )} \cdot {S}_{out - face ( i )}}{\sum {\overline{S}}_{face ( i )}} ;$$

Where, P_{diff} is the area weighted pressure difference of the total surface grid on the inner and outer sides, P_{in-face(i)} is the pressure of the surface grid with inner number i, S_{in-face(i)} is the area of the surface grid with inner number i. Similarly, P_{out-face(i)} is the pressure of the surface grid with outer number i, S_{out-face(i)} is the area of the surface grid with outer number i, and S̅_{face(i)} is the average area of the corresponding surface grid on the inner and outer sides;

When the area weighted pressure difference exceeds the set minimum pressure threshold Pₜₕᵣ, the explosion venting plate will be activated, and the wall boundary will gradually transform into a cyclic boundary at a constant rate. The state function is:

$${x}_{new} = {x}_{old} + {s}_{oir} \times \frac{dt}{DT} ;$$

Where, x_{new} is the opening score of the venting plate, ranging from 0 to 1, x_{old} is the opening score of the previous time step, sₒᵢᵣ is the opening or closing signal, 1 is opening, −1 is closing, dt is the simulation time step, and DT is the set total opening time of the explosion venting plate.

Preferably, the modeling method is implemented based on the open source computational fluid dynamics software OpenFOAM.

In summary, the invention proposes a modeling method for energy storage tank explosion venting to prevent thermal runaway gas explosion in lithium-ion batteries. Firstly, a one-dimensional combustion model is constructed to calculate the laminar burning velocity and related thermophysical parameters of the gas emitted from lithium-ion batteries. Secondly, the geometric modeling and grid of the actual size battery energy storage tank are established, the premixed area inside the tank and the air area outside the tank are divided, and a special coupling boundary is set in the predetermined explosion venting area to achieve the explosion venting function. Then, the calculated combustion characteristic parameters of the mixed gas are used as input to solve the three-dimensional combustion and explosion model, obtaining the evolution characteristics and laws of the thermal runaway emission gas explosion in the lithium-ion battery, and achieving risk assessment of the explosion venting safety design of the energy storage tank. Compared with existing technology, it has the following benefits:

(1) The invention calculates the pre-combustion characteristic parameters based on the actual mixed gas composition and proportion of thermal runaway emissions from lithium-ion batteries, which solves the problem of existing equivalent gas models ignoring the differences and changes in the thermal runaway emissions of different lithium-ion batteries, and improves the prediction accuracy of gas explosions in energy storage tanks.

(2) The model proposed by the invention comprehensively covers the entire process from accurately predicting the combustion characteristics of gas produced by lithium-ion batteries, to venting after the explosion of premixed gas in the tank, and finally simulating the degree of disaster after venting, making up for the shortcomings of previous research on venting after thermal runaway gas explosion in lithium-ion batteries in energy storage tanks:

(3) The invention can study the evolution law of thermal runaway gas explosion in lithium-ion batteries in energy storage tanks under different working conditions by changing a series of parameters. At the same time, it is possible to predict the degree of damage to the tank and surrounding environment caused by internal explosions in energy storage tanks with explosion venting design, providing a basis for the safety design of energy storage systems:

(4) The invention can be extended to predict the disaster degree of thermal runaway gas explosion in lithium-ion batteries with different electrode materials under different energy storage tank explosion venting designs, providing a model paradigm and framework for researchers in energy storage tank safety design, and providing basis and guidance for the prevention and control design of gas explosions in energy storage tanks.

### BRIEF DESCRIPTION OF DRAWINGS

FIG. 1 shows a flowchart illustrating an energy storage tank explosion venting modeling method for thermal runaway gas explosion in lithium-ion batteries proposed in the embodiment of the invention;

FIG. 2 shows the comparison of laminar burning velocities of gases emitted by different lithium-ion batteries obtained through experiments and simulations in the embodiment of the invention;

FIG. 3 shows the geometric and grid schematic diagram of the three-dimensional energy storage tank model designed in the embodiment of the invention;

FIG. 4 shows the results of high-temperature flame evolution after gas explosion in an energy storage tank without venting design obtained by a venting modeling method for thermal runaway gas explosion in the lithium-ion battery using an embodiment of the invention;

FIG. 5 shows the results of high-temperature flame evolution after gas explosion in an energy storage tank under a uniform venting design in the top area, obtained by a venting modeling method for thermal runaway gas explosion in the lithium-ion battery using an embodiment of the invention.

### DETAILED DESCRIPTION OF THE EMBODIMENTS

To make the technical solution and advantages of the invention clearer, a clear and complete description of the technical solution of the invention in conjunction with specific embodiments and accompanying drawings will be provided. Obviously, the described embodiments are a part of the embodiments of the invention, not all of them; Based on the embodiments in the invention, all other embodiments obtained by those skilled in the art without making creative efforts fall within the scope of protection of the invention.

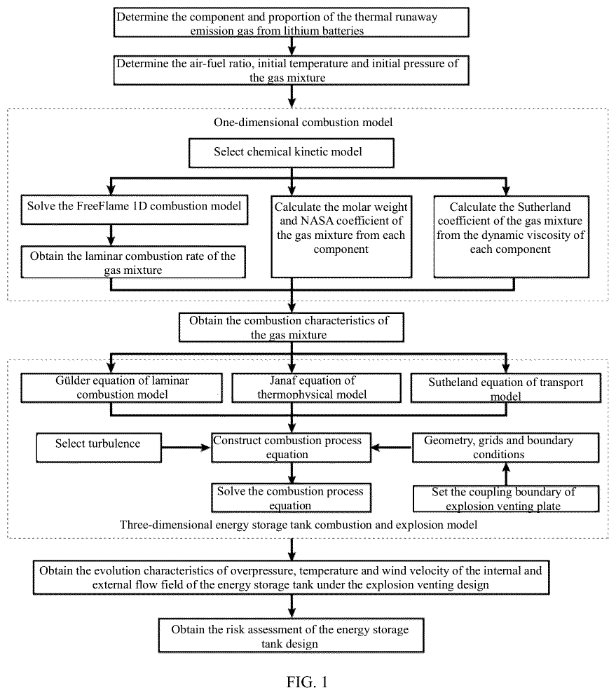

As shown in FIG. 1, Embodiment 1 of the invention provides an energy storage tank explosion modeling method for thermal runaway gas explosion in lithium-ion batteries, comprising the following steps:

Step 1: Determine the type of lithium-ion battery and obtain the classification and proportion of the mixed gas produced after thermal runaway. By selecting a lithium-ion battery, the mixed gas produced after thermal runaway can be obtained, and the classification and proportion of each group in the gas can be determined.

Step 2: Based on the actual proportion of the mixed gas obtained in Step 1, import the one-dimensional combustion model to calculate the laminar burning velocity of the mixed gas, and calculate the thermophysical parameters at the same time.

Step 3: Set the coupling boundary of the explosion venting plate, divide the premixed area in the tank and the air area outside the tank, establish the geometric modeling and grid of the battery energy storage tank, and establish the three-dimensional combustion process equation according to the boundary conditions;

Step 4: Take the laminar burning velocity and thermophysical parameters of the mixed gas obtained in Step 2 as inputs to solve the three-dimensional combustion process equation, and obtain the evolution characteristics of overpressure, temperature, and wind speed of the internal and external flow fields of the energy storage tank under the explosion venting design, and complete the risk assessment of the explosion venting design of the energy storage tank.

The mixture of gases emitted by lithium-ion batteries due to thermal runaway is composed of different gases, including but not limited to hydrogen, carbon monoxide, carbon dioxide, methane, ethylene, ethane, etc. The combustion characteristics of the mixture are jointly determined by each component and its proportion. Therefore, after determining the types and proportions of various components of the mixed gas in Step 1, the combustion characteristics parameters of the mixed gas and serve as input for Step 4 will be further calculated. The following provides a detailed introduction to the calculation principles and methods of each step in the embodiments of the invention.

### (1) Calculate Laminar Burning Velocity of Mixed Gases

In this embodiment, the laminar burning velocity model is established based on the Gülder equation, and its basic formula includes:

$${S}_{L} ( ϕ , T , p ) = {ωϕ}^{n} {e}^{ξ ( ϕ - 1.075 )} \cdot {( \frac{T}{{T}_{ref}} )}^{α} \cdot {( \frac{p}{{p}_{ref}} )}^{β} \cdot ( 1 - {X}_{f} \cdot f ) ; \qquad ( 1 )$$

Where, S_{L} (φ, T, p) is the laminar burning velocity, φ is the air equivalence ratio of the mixed gas, T is the temperature and p is the pressure, ω, η, ξ, α, B and f are Gülder coefficients, T_{ref} is the reference temperature, p_{ref} is the reference pressure, and X_{f} is the molar fraction of the inert gas: In the Gülder equation, the f coefficient is set to 2.3, which is independent of the composition of the mixed gas. Additionally, the five coefficients of [symbol] β need to be estimated. Specifically, the Gülder coefficients mentioned above are fitted in three steps by the one-dimensional combustion model in Step 2, which is established based on the FreeFlame equation. By solving the steady-state solutions of one-dimensional free propagation, planar, and adiabatic flames, the laminar burning velocity of the mixed gas is obtained:

$${S}_{L} ( ϕ ) = {ωϕ}^{n} {e}^{ξ ( ϕ - 1.075 )} ; \qquad ( 2 )$$

$${S}_{L} ( T ) = {S}_{L} ( ϕ = 1 , {T}_{ref} , {p}_{ref} ) {( \frac{T}{{T}_{ref}} )}^{α} ; \qquad ( 3 )$$

$${S}_{L} ( p ) = {S}_{L} ( ϕ = 1 , {T}_{ref} , {p}_{ref} ) {( \frac{p}{{p}_{ref}} )}^{β} \qquad ( 4 )$$

Where, S_{L} (φ), S_{L} (P) and S_{L} (T) respectively represent the variation of laminar burning velocity with equivalence ratio at constant pressure and temperature, the variation of laminar burning velocity with temperature at constant volume ratio and constant pressure, and the variation of laminar burning velocity with pressure under constant temperature and constant volume ratio conditions.

The relevant control equations are listed in Table 1. By using the control equation in Table 1, the values of S_{L} (φ), S_{L} (P) and S_{L} (T) can be calculated and can be fitted using Formulas (2) to (4) to obtain the values of ω, η, ξ, α and β.

TABLE 1
Control equations for one-dimensional combustion dynamics model

| Type | Equation form |
|---|---|
| Continuity equation | $\dot{m} = ρ uA = cons$ |
| Gas conservation equation | $ρ u \frac{δ {Y}_{i}}{δ x} + \frac{δ {J}_{i}}{δ x} = {\dot{ω}}_{i} {W}_{i}$ |
| Energy conservation equation | $ρ {uC}_{p} \frac{δ T}{δ x} = \frac{δ}{δ x} ( λ \frac{δ T}{δ x} ) - {\sum }_{i} {h}_{i} {\dot{ω}}_{i} {W}_{i} - {\sum }_{i} {J}_{i} {C}_{p , i} \frac{δ T}{δ x}$ |

### (2) Calculate Thermophysical Parameters of Mixed Gases

In this embodiment, when solving the three-dimensional combustion process equation of non-uniform combustion in Step 4, a specific parameter and three species parameters of the mixed gas need to be input. The specific parameter is the stoichiometric air fuel mass ratio. The molar mass, molar weighted NASA polynomial coefficient and Sutherland coefficient are three specific species parameters. The molar mass is the molar mass of each component in the mixed gas.

The calculation formula of Stoichiometric air fuel mass ratio AFRₛₜ and equivalence ratio φ is as follows:

$${AFR}_{st} = {( \frac{{m}_{air}}{{m}_{fuel}} )}_{stoic} ; \qquad ( 5 )$$

$$ϕ = \frac{\frac{{m}_{fuel}}{{m}_{oxidizer}}}{{( \frac{{m}_{fuel}}{{m}_{oxidizer}} )}_{stoic}} ; \qquad ( 6 )$$

Where, mₐᵢᵣ is air mass, m_{fuel} is the mass of combustible gas mixture, stoic is the appropriate and complete combustion of the fuel, and m_{oxidizer} is the mass of the oxidant.

In addition, in the three-dimensional combustion model in Step 4, the calculation of the thermophysical properties of the mixed gas is based on the Janaf model, which relies on two sets of model coefficients. In the set temperature range Tₜ to Tₕ, when the temperature is below the threshold temperature T_{c}, the polynomial coefficient adopts the lowCpCoeffs coefficient; When the temperature is higher than T_{c}, the polynomial coefficient adopts the highCpCoeffs coefficient. The specific equation is as follows:

$${a}_{i} = ( \begin{matrix}{T}_{l} \leq T < {T}_{c} : lowlowCpcoeffs \\ {T}_{c} \leq T \leq {T}_{h} : highCpCoeffs\end{matrix} ; \qquad ( 7 )$$

$$\frac{{C}_{p} ( T )}{{R}_{u}} = {a}_{0} + {a}_{1} T + {a}_{2} {T}^{2} + {a}_{3} {T}^{3} + {a}_{4} {T}^{4} ; \qquad ( 8 )$$

$$\frac{h ( T )}{{R}_{u}} = {a}_{0} T + \frac{{a}_{1} {T}^{2}}{2} + \frac{{a}_{2} {T}^{3}}{3} + \frac{{a}_{3} {T}^{4}}{4} + \frac{{a}_{4} {T}^{5}}{5} + {a}_{5} ; \qquad ( 9 )$$

$$\frac{s ( T )}{{R}_{u}} = {a}_{0} ln T + {a}_{1} T + \frac{{a}_{2} {T}^{2}}{2} + \frac{{a}_{3} {T}^{3}}{3} + \frac{{a}_{4} {T}^{4}}{4} + {a}_{6} ; \qquad ( 10 )$$

Where, aᵢ is the coefficient of the index i in the polynomial, Cₚ is the constant pressure specific heat capacity, Rᵤ is the general gas constant, h is the enthalpy value, s is the entropy value, T is the temperature, a₀ is the polynomial coefficient velocity vector, and a₁, a₂, a₃, a₄, a₅ and a₆ are polynomial coefficients: These polynomial coefficients are calculated based on NASA polynomials. The thermodynamic parameters of the mixed gas are calculated based on the molar weighting of each component, and the molar weighted NASA polynomial coefficients are as follows:

$$\overline{{a}_{i}} = {\sum }_{i = 0}^{k} {a}_{i , k} {X}_{k} ; \qquad ( 11 )$$

Where, i is the polynomial index, k is the component, āᵢ is the coefficient of the index i in the molar weighted polynomial, a_{i, k} is the coefficient of the index i in the polynomial of component k, and Xx is the molar fraction of component k. The components in the mixed gas may have different reference temperatures, leading to deviations in the thermodynamic characteristics of certain temperature regions of the mixed gas. Therefore, for different reference temperatures of each component, the species with the highest molar fraction will determine the reference temperature of the mixed gas. Therefore, the values of polynomial coefficients a₁, a₂, a₃, a₄, a₅ and a₆ can be obtained through Formula (11) weighted calculation. Then, a suitable set of polynomial coefficients can be selected through Formula (7), and the thermophysical parameters of the mixed combustible gas can be calculated through Formulas (8) to (10).

The Sutherland equation serves as the transfer equation in the three-dimensional combustion model in Step 4, used to calculate the dynamic gas viscosity μ:

$$μ = \frac{{A}_{s} \sqrt{T}}{1 + \frac{{T}_{s}}{T}} ; \qquad ( 12 )$$

Where, μ is the dynamic gas viscosity, Aₛ and Tₛ are the Sutherland coefficients, and T is the temperature. Based on the reaction mechanism and initial conditions, the Sutherland coefficient can be obtained by fitting and calculating the dynamic viscosity of mixed gases, oxidants, and combustion products.

### (3) Build a Three-Dimensional Combustion Model

For premixed combustion of mixed gases and air, under the one-step assumption with unit Lewis number and adiabatic conditions, the species migration equation of combustion can be simplified as a single combustion process variable equation:

$$\frac{\partial ( ρ c )}{\partial t} + \frac{\partial ( ρ {\tilde{u}}_{i} c )}{\partial {x}_{i}} = \frac{\partial }{\partial {x}_{i}} [ ( ρα + \frac{{μ}_{t}}{{Sc}_{t}} ) \frac{\partial c}{\partial {x}_{i}} ] + {\dot{ω}}_{c} ; \qquad ( 13 )$$

Where, the transfer variable c is the normalized mass fraction of combustion products, which is called the process variable. The combustion process variables describe the thermochemical state of a mixed gas at any point in time and space. Further addition of closed models (turbulence, reaction rate source terms, and turbulent flame velocity), as well as the thermophysical and transport parameters of unburned/burned mixtures and flames, collectively express the propagation of premixed flames. In a three-dimensional combustion model, the solution is the regression variable b, which adds up to 1 with the process variable c. In Formula 13, the molecular thermal diffusivity α is usually much smaller than the turbulent diffusion rate μₜScₜ, which can be simply ignored in the combustion model, therefore, it is further rewritten as follows:

$$\frac{\partial ( ρ b )}{\partial t} + \frac{\partial ( ρ {\tilde{u}}_{i} b )}{\partial {x}_{i}} = \frac{\partial }{\partial {x}_{i}} ( \frac{{μ}_{t}}{{Sc}_{t}} \cdot \frac{\partial b}{\partial {x}_{i}} ) - {\dot{ω}}_{b} ; \qquad ( 14 )$$

Where, ρ is density, b is the combustion regression variable, ũᵢ is the velocity vector, μₜ is the dynamic viscosity under turbulent state, Scₜ is the turbulent Schmidt number. \dot{ω}_{b·} is the source term of reaction rate, and the calculation formula is:

$${\dot{ω}}_{b \cdot } = {ρ}_{u} {S}_{u} Ξ \vert ∇ b \vert ; \qquad ( 15 )$$

Where, ρᵤ is the density of the unburned mixture, Sᵤ is the laminar flame rate; Ξ is the flame subgrid fold factor, considered as the ratio of turbulent and laminar flame velocity, and can be evaluated through algebraic methods:

$$\frac{\partial Ξ}{\partial t} + {U}_{s} \cdot ∇ Ξ = G Ξ - R ( {Ξ}_{i} - 1 ) + ( {σ}_{s} - {σ}_{t} ) Ξ ; \qquad ( 16 )$$

Uₛ is the filtration rate of the flame surface, G is the turbulence generation rate, and R is the turbulence removal rate, o, is the surface filtration strain rate, σ T is the decomposed strain rate, and their respective control equations are listed in Table 2.

TABLE 2
Control equations for some physical parameters in the
three-dimensional combustion model

| Physical parameters | Equation form |
|---|---|
| Surface filtration strain rate | ${σ}_{s} = \frac{∇ \cdot {U}_{s} - \hat{n} \cdot ( ∇ {U}_{s} ) \cdot \hat{n}}{Ξ} + \frac{\begin{matrix}( Ξ + 1 ) ( ∇ \cdot ( {S}_{u} \hat{n} ) - \\ \hat{n} \cdot ( ∇ \cdot ( {S}_{u} \hat{n} ) ) \cdot \hat{n}\end{matrix}}{2 Ξ}$ |
| Turbulence generation rate | $G = R \frac{{Ξ}_{eq} - 1}{{Ξ}_{eq}}$ |
| Turbulence removal rate | $R = \frac{0.28}{τ} \cdot \frac{\partial {Ξ}_{eq}}{{Ξ}_{eq}^{*} - 1}$ |
| Decomposition strain rate | ${σ}_{t} = ∇ \cdot ( {U}_{s} + {S}_{u} Ξ \hat{n} ) - \hat{n} \cdot ( ∇ ( {U}_{s} + {S}_{u} Ξ \hat{n} ) ) \cdot \hat{n}$ |

### (4) Construct Explosion Venting Plate

The setting of the venting plate couples the composite boundary conditions of the wall and the cyclic boundary to simulate the process of the venting plate from closing to opening due to the pressure difference between the inside and outside. The coupling boundary connects the surface grid areas on both sides of the set area. At the initial state, the coupling boundary is used as the wall state, and then each time step will iterate the surface cell states on both sides of the boundary and calculate the area weighted pressure difference on both sides:

$${P}_{diff} = \frac{\sum {P}_{i n - face ( i )} \cdot {S}_{i n - face ( i )} - \sum {P}_{out - face ( i )} \cdot {S}_{out - face ( i )}}{\sum {\overline{S}}_{face ( i )}} \qquad ( 17 )$$

Where, P_{diff} is the area weighted pressure difference of the total surface grid on the inner and outer sides, P_{in-face(i)} is the pressure of the surface grid with inner number i, S_{in-face(i)} is the area of the surface grid with inner number i. Similarly, P_{out-face(i)} is the pressure of the surface grid with outer number i, S_{out-face(i)} is the area of the surface grid with outer number i, and S̅_{face(i)} is the average area of the corresponding surface grid on the inner and outer sides: When the area weighted pressure difference exceeds the set minimum pressure threshold Pₜₕᵣ, the explosion venting plate will be activated, and the wall boundary will gradually transform into a cyclic boundary at a constant rate. The state function is:

$${x}_{n e w} = {x}_{o l d} + {s}_{o i r} \times \frac{d t}{D T} \qquad ( 18 )$$

Where, x_{new} is the opening score of the venting plate, ranging from 0 to 1, x_{old} is the opening score of the previous time step, sₒᵢᵣ is the opening or closing signal, 1 is opening, −1 is closing, dt is the simulation time step, and DT is the set total opening time of the explosion venting plate. When x_{new} changes to 1, it is a complete transition of the coupling boundary from a wall boundary to a circular boundary, with the inside and outside being the same, and this process is irreversible.

Furthermore, the calculation process of this method involves clearly selecting the types and proportions of thermal runaway gas emissions from lithium-ion batteries, inputting them into a one-dimensional combustion model and program, calculating the laminar burning velocity and thermophysical characteristics adoption number of mixed combustible gases, and further importing them into a three-dimensional combustion model with specific coupled boundary conditions to predict the combustion flow field characteristics of the energy storage tank after the explosion of this mixed gas and evaluate the disaster risk of explosion venting design on the energy storage tank and surrounding environment. This process is reproduced in the open source computational fluid dynamics software OpenFOAM, and the calculation process is shown in FIG. 1 of the specification. The symbols and terms used in the text are shown in Table 3.

TABLE 3
Symbols and terminology

| | |
|---|---|
| A | Area (m²) |
| Aₛ, Tₛ | Sutherland coefficient (−) |
| a₀ | Polynomial coefficient velocity vector (m/s) |
| aᵢ | Coefficient of index i (−) |
| a_{i,k} | The index i coefficient in the multi-directional |
| | equation of component k (−) |
| āᵢ | Molar weighted polynomial index i coefficient |
| | (−) |
| b | Combustion regression variable (−) |
| Cₚ | Constant pressure specific heat capacity (J/K) |
| C_{p,i} | Heat capacity of gas i (J/K) |
| c | Process variables (−) |
| DT | Total opening time of the set explosion |
| | venting plate (s) |
| dt | Simulated time step (s) |
| G | Turbulence generation rate (−) |
| h | Enthalpy value (KJ/kg) |
| hᵢ | Enthalpy value of gas i (KJ/kg) |
| i | Polynomial index (−) |
| Jᵢ | Diffusion mass flux of gas i (kg/m² s) |
| k | Component (−) |
| \dot{m} | Mass flow rate (kg/s) |
| P_{diff} | Area weighted pressure difference between |
| | the inner and outer total surface grids (Pₐ) |
| P_{in-face(i)} | Pressure of the surface grid with |
| | inner number i (Pa) |
| P_{out-face(i)} | Pressure of the surface grid with |
| | outer number i (Pa) |
| p | Pressure (Pa) |
| P_{ref} | Reference pressure (Pₐ) |
| R | Turbulence removal rate (−) |
| Ru | General gas constant (−) |
| R_{η} | Kolmogorov Reynolds number (−) |
| Scₜ | Turbulent Schmidt number (−) |
| S̅_{face(i)} | The average area of the surface grid |
| | corresponding to the inner and outer sides (m²) |
| S_{L} | Laminar burning velocity (m/s) |
| S_{in-face(i)} | Surface grid area with inner number i (m²) |
| S_{out-face(i)} | Surface grid area with outer number i (m²) |
| Sᵤ | Laminar flame velocity (m/s) |
| s | Entropy value (J/K) |
| sₒᵢᵣ | On or Off Signal (−) |
| T | Temperature (K.) |
| T_{ref} | Reference temperature (K.) |
| Yᵢ | Mass fraction of gas i (%) |
| Uₛ | Flame surface filtration rate (m/s) |
| u | Flow velocity (m/s) |
| u′ | Subgrid turbulence intensity (−) |
| ũᵢ | Velocity vector (m/s) |
| Wᵢ | Molar weight of gas i (g/mol) |
| Xₖ | Molar fraction of component k (−) |
| X_{f} | Molar fraction of inert gas (−) |
| x_{new} | Explosion venting plate opening score (−) |
| x_{old} | Opening score of the previous time step (−) |
| Y_{F} | Mass fraction of fuel (%) |
| Y_{F,b} | Mass fraction of burned fuel (%) |
| Y_{F,u} | Mass fraction of unburned fuel (%) |
| Greek alphabet | |
| λ | Thermal conductivity (W/m K) |
| μ | Dynamic viscosity (m²/s) |
| Ξ | Flame subgrid wrinkle factor (−) |
| ρ | Density (kg/m³) |
| ρᵤ | Density of unburned mixture (kg/m³) |
| σₛ | Surface filtration strain rate (−) |
| σₜ | Decomposition strain rate (−) |
| τ | Kolmogorov time scale (−) |
| φ | Air equivalence ratio of mixed gases (−) |
| ωᵢ | Molar reaction rate of gas i (mol/L s) |
| \dot{ω}_{b}. | Reaction velocity source term (m/s) |
| ω, η, ξ, α, β, ƒ | Gülder coefficient (−) |

### Experimental Examples

(1) Calculation of Combustion Characteristics Parameters of Gases Discharged from Lithium-Ion Batteries Due to Thermal Runaway

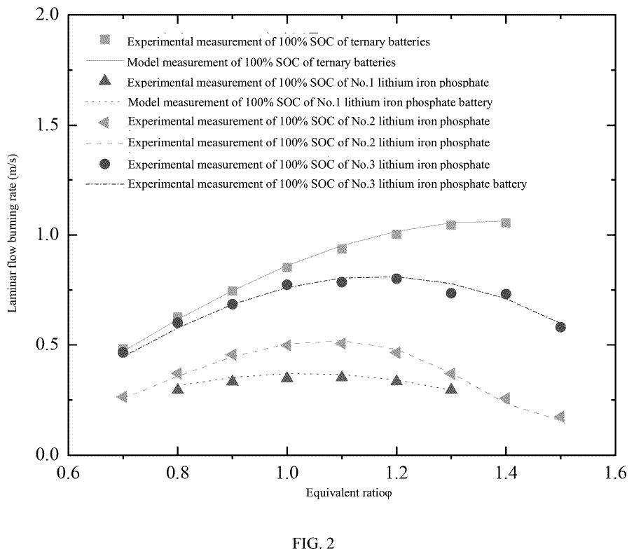

Firstly, obtain the composition and proportion of thermal runaway emission gases from the test battery through experiments or literature research. Secondly, determine parameters such as the air fuel ratio, initial temperature, and initial pressure of the mixed gas. Import these basic parameters of emitted gases into a one-dimensional combustion model. Because the combustion process often involves many chemical components and a series of elementary reaction mechanisms, it is necessary to select the chemical kinetics model from the one-dimensional combustion model. Generally, for mixed gases with carbon dioxide content below 15%, the GRI-Mech 3.0 reaction mechanism can be used, while for mixed gases with carbon dioxide content above 15%, the San Diego reaction mechanism can be used. The one-dimensional combustion model will synchronously calculate the laminar burning velocity, molar weight, NASA polynomial coefficient, and dynamic viscosity coefficient of the mixed gas. As shown in FIG. 2, the laminar burning velocity obtained from experimental measurements of gases emitted from different lithium-ion batteries due to thermal runaway is in good agreement with the predicted data of the one-dimensional combustion model, which proves the effectiveness of the model of the invention. At the same time, through the study of different lithium iron phosphate battery, it is found that due to the differences in electrolyte materials and manufacturing processes, the composition and proportion of thermal runaway emissions are different, so the laminar burning velocity of mixed gases is also different. This further demonstrates that the invention can fully consider the differences and changes in the thermal runaway emissions of different lithium-ion batteries when predicting gas explosions in energy storage tanks, thereby improving prediction accuracy.

### (2) Part of Establishing a Combustion Model for Gas Explosion in Energy Storage Tanks

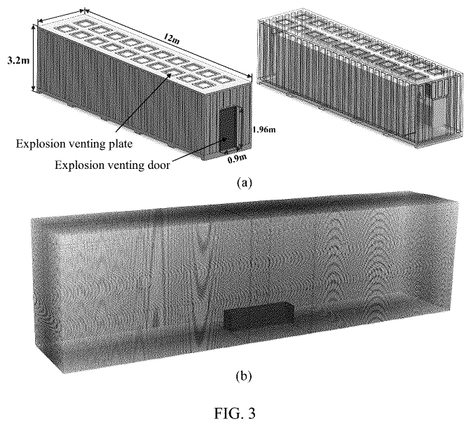

According to the actual size and layout of the lithium-ion battery storage tank, build a geometric modeling and divide the grid. As shown in FIG. 3, the two FIG.s in (a) respectively represent the shape and approximate size of the energy storage tank, with explosion venting doors on both sides, explosion venting plates on the top, and a certain number of battery energy storage cabinets and control cabinets installed on both sides of the interior: (b) in the FIG. is the grid diagram of the geometric modeling. The geometric modeling includes two calculation areas, the premixed area of mixed gas and air inside the tank and the air area outside the tank. Inside the tank, a series of energy storage battery cabinets and related supporting power conversion cabinets are installed on both sides; on the top of the energy storage tank, evenly distributed explosion venting plates are installed; a pair of explosion venting doors are installed on both sides of the short side of the tank. These venting devices are established through specific coupling boundary conditions and set venting thresholds to simulate venting activation pressure. The size of the entire calculation area is 80.0 m×20.0 m×20.0 m. The boundaries of the calculation model include the ground, the inner wall of the tank, the explosion venting door, the top explosion venting plate, the outer wall of the tank, and the air surface. Due to the strong coupling effect between turbulent flow and chemical reactions during the combustion process, large eddy simulation is chosen as the turbulence model in the example to accurately capture the turbulent characteristics during the combustion process and improve the accuracy of the simulation results.

### (3) Part of Evolutionary Calculation of Thermal Runaway Gas Explosion Process in Energy Storage Tanks

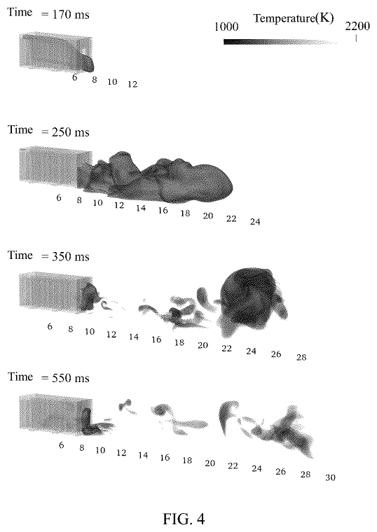

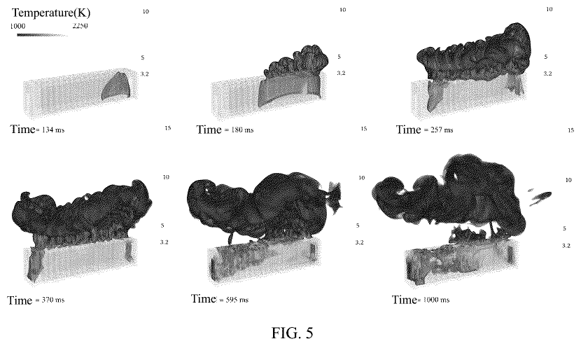

After obtaining the combustion characteristics parameters of the gas discharged from the thermal runaway of the lithium-ion battery, they are input into the combustion model of the energy storage tank to calculate the combustion process equation, which is respectively calculated with the assistance of the laminar combustion model, thermophysical model, and transport model. The combustion model of the energy storage tank will calculate the parameters such as shock wave overpressure, flame temperature, flame laminar burning velocity, flame turbulent combustion rate, wind speed, and gas density caused by the thermal runaway exhaust gas of the lithium-ion battery detonated at the set ignition source. Considering the limited space, the following mainly introduces the flame temperature. Aₛ shown in FIG. 4, when the explosion-proof design is not considered for the energy storage tank, the combustion gas can only be released through the explosion venting doors on both sides. In this model, the activation threshold of the venting door is set to 0) kPa, representing no venting pressure, and the combustion gas can directly pass through the bilateral doors. The calculation results indicate that although there is no venting pressure, the jet fire caused by gas explosion in the tank is accompanied by combustion waves and transmitted to a distance of 22 meters away from the door, with a maximum height of over 7 meters. This means that on both sides of the short side of the energy storage tank, the area within 22 meters of the energy storage tank is a dangerous area, and once there are personnel or important facilities, they will be affected and threatened. After introducing a uniformly distributed venting plate design on the top of the energy storage tank, the activation pressure value of the top venting plate is 2 kPa, and the activation pressure value of the venting doors on both sides is 10 kPa. As shown in FIG. 5, after the activation of the top venting plate, the combustion gas inside the tank induces external combustion to occur in the top area of the energy storage tank, and the pressure inside the tank does not exceed the activation pressure of the venting door. Therefore, no external combustion occurs outside the doors on both sides of the energy storage tank, reducing the threat to surrounding personnel and facilities, and greatly reducing the risk and disaster of gas explosion accidents in the energy storage tank.

Based on the above analysis of the calculation results of the thermal runaway gas explosion model of the lithium-ion battery in the energy storage tank, it can be concluded that the energy storage tank explosion modeling method described in the invention is aimed at the thermal runaway gas explosion of the lithium-ion battery, taking into account the differences in gas emissions from different lithium-ion batteries, and can accurately predict key parameters such as overpressure, flame temperature, flame rate, and hurricane field in the internal and external flow fields of the energy storage tank to complete the risk assessment of gas explosion in energy storage tanks and the surrounding environment under different explosion venting designs. The invention can be extended to predict the disaster degree of thermal runaway gas explosion in lithium-ion batteries with different electrode materials under different energy storage tank explosion venting designs, providing a model paradigm and framework for researchers in energy storage tank safety design, and providing basis and guidance for the prevention and control design of gas explosions in energy storage tanks. Therefore, the invention has important application value and promotion significance.

The embodiments of the invention have been described in detail above in conjunction with the accompanying drawings, but the invention is not limited to the aforementioned embodiments. Within the scope of knowledge possessed by ordinary technical personnel in the art, various changes can be made without departing from the purpose of the invention.

1. A modeling method for energy storage tank explosion venting to prevent thermal runaway gas explosion in lithium-ion batteries comprising following steps:
step 1: determining a type of lithium-ion battery and obtain classification and a proportion of mixed gas produced after thermal runaway;
step 2: based on actual proportion of the mixed gas obtained in step 1, importing a one-dimensional combustion model to calculate a laminar burning velocity of the mixed gas, and thermophysical parameters at the same time;
step 3: establishing a geometric modeling and grid of an energy storage tank, dividing a premixed area in the energy storage tank and an air area outside the energy storage tank, setting the coupling boundary of explosion venting plates, and the establishing a three-dimensional combustion process equation according to boundary conditions; and
step 4: considering the laminar burning velocity and the thermophysical parameters of the mixed gas obtained in the step 2 as inputs to solve the three-dimensional combustion process equation, and obtaining evolution characteristics of overpressure, temperature, and wind speed of internal and external flow fields of the energy storage tank under an explosion venting design, and completing a risk assessment of the explosion venting design of the energy storage tank for applying the explosion venting design to the energy storage tank, wherein
in step 4, a specific method for solving the three-dimensional combustion process equation is:
at an initial state, the coupling boundary is used as a wall state, and then each time step iterates surface cell states on both sides of the boundary and calculate area weighted pressure difference on both sides, wherein a calculation formula is:
$${P}_{diff} = \frac{\sum {P}_{i n - face ( i )} \cdot {S}_{i n - face ( i )} - \sum {P}_{out - face ( i )} \cdot {S}_{out - face ( i )}}{\sum {\overline{S}}_{face ( i )}} ;$$
where, P_{diff} is the area weighted pressure difference of a total surface grid on inner and outer sides, P_{in-face(i)} is pressure of a surface grid with inner number i, S_{in-face(i)} is an area of the surface grid with the inner number i; P_{out-face(i)} is pressure of the surface grid with an outer number i, S_{out-face(i)} is an area of the surface grid with the outer number i, and S̅_{face(i)} is an average area of a corresponding surface grid on the inner and outer sides;
when the area weighted pressure difference exceeds a set minimum pressure threshold Pₜₕᵣ, the explosion venting plate will be activated, and a wall boundary will gradually transform into a cyclic boundary at a constant rate; the state function is:
$${x}_{n e w} = {x}_{o l d} + {s}_{o i r} \times \frac{d t}{D T} ;$$
where, x_{new} is an opening score of the explosion venting plate, ranging from 0 to 1, x_{old} is an opening score of a previous time step, sₒᵢᵣ is opening or closing signal, 1 is an opening signal, −1 is a closing signal, dt is a simulation time step, and DT is a set total opening time of the explosion venting plate,
wherein the explosion venting design obtained by the modeling method is applied to the energy storage tank where an activation pressure of venting doors is higher than an activation pressure of top venting plates; and the top venting plates of the energy storage tank are activated when gas explosion occurs in the energy storage tank, thereby combustion gas inside the energy storage tank induces external combustion to occur in a top area of the energy storage tank, and the pressure inside the tank does not exceed the activation pressure of venting doors, such that no external combustion occurs outside the venting doors on both sides of the energy storage tank which in turn reduces threat to surrounding personnel and facilities and risk and disaster of gas explosion accidents in the energy storage tank.

2. The method of claim 1, wherein, in step 2, a calculation formula for the laminar burning velocity is:
$${S}_{L} ( ϕ , T , p ) = {ωϕ}^{η} {e}^{ξ ( Φ - 1075 )} \cdot {( \frac{T}{{T}_{r e f}} )}^{α} \cdot {( \frac{p}{{p}_{r e f}} )}^{β} \cdot ( 1 - {X}_{f} \cdot f ) ;$$
where, S_{L} is the laminar burning velocity, φ is an air equivalence ratio of the mixed gas, T is temperature and p is pressure, ω, η, ξ, α, β and f are Gülder coefficients, T_{ref} is a reference temperature, p_{ref} is a reference pressure, and X_{f} is a molar fraction of inert gas,
wherein the Gülder coefficient is obtained by solving steady-state solutions for one-dimensional free propagation, planar, and adiabatic flames.

3. The method of claim 2, wherein a calculation method of the Gülder coefficient comprises:
calculating values of S_{L} (φ), S_{L}(P) and S_{L}(T) through a control equation of the one-dimensional combustion model;
fitting curve fitting equations of SL (φ), SL(P) and SL(T) to obtain a value of the Gülder coefficient, wherein the curve fitting equations include:
$${S}_{L} ( ϕ ) = {ωϕ}^{η} {e}^{ξ ( ϕ - 1.075 )} ;$$
$${S}_{L} ( T ) = {S}_{L} ( ϕ = 1 , {T}_{r e f} , {p}_{r e f} ) {( \frac{T}{{T}_{r e f}} )}^{α} ;$$
$${S}_{L} ( p ) = {S}_{L} ( ϕ = 1 , {T}_{r e f} , {p}_{r e f} ) {( \frac{p}{{p}_{r e f}} )}^{β} .$$

4. The method of claim 3, wherein the control equation of the one-dimensional combustion model includes:
$$\underline{a continuity} equation : \dot{m} = ρ uA = cons ;$$
$$[ [ Gas ] ] \underline{a gas} conservation equation : ρ u \frac{δ {Y}_{i}}{δ x} + \frac{δ {J}_{i}}{δ x} = {\dot{ω}}_{i} {W}_{i} ;$$
$$\underline{and} \underline{an energy} conservation equation : ρ {uC}_{p} \frac{δ T}{δ x} = \frac{δ}{δ x} ( λ \frac{δ T}{δ x} ) - {\sum }_{i} {h}_{i} {\dot{ω}}_{i} {W}_{i} - {\sum }_{i} {J}_{i} {C}_{p , i} \frac{δ T}{δ x} ;$$
where, \dot{m} is a mass flow rate, ρ is density, u is a gas flow rate, cons is a constant, Yᵢ is a mass fraction of gas i, Jᵢ is a diffusion mass flux of gas i, x is a position, \dot{ω}ₜ is a molar fraction of gas i, Wᵢ is a molar weight of gas i; Cₚ is a constant pressure specific heat capacity, T is the temperature, λ is a thermal conductivity, hᵢ is an enthalpy value of gas i, C_{p, i} is a heat capacity of gas i.

5. The method of claim 1, wherein, in step 2, the thermophysical parameters include an air fuel mass ratio, a molar weight, molar weighted NASA polynomial coefficient, and a Sutherland coefficient, wherein a calculation formula for the air fuel mass ratio is:
$$A F {R}_{st} = {( \frac{{m}_{air}}{{m}_{f u e l}} )}_{stoic} ;$$
where, mₐᵢᵣ is air mass, m_{fuel} is a mass of combustible gas mixture, and stoic is appropriate and complete combustion of fuel;
a calculation formula for the molar weighted NASA polynomial coefficients is:
$$\overline{{a}_{i}} = {\sum }_{i = 0}^{k} {a}_{i , k} {X}_{k}$$
where, i is a polynomial index, k is a component, āᵢ is a coefficient of an index i in molar weighted polynomial, a_{i, k} is a coefficient of the index i in a polynomial of component k, and Xₖ is a molar fraction of component k;
$${a}_{i} = ( \begin{matrix}{T}_{l} \leq T < {T}_{c} : lowlowCpcoeffs \\ {T}_{c} \leq T \leq {T}_{h} : highCpCoeffs\end{matrix} ;$$
$$\frac{{C}_{p} ( T )}{{R}_{u}} = {a}_{0} + {a}_{1} T + {a}_{2} {T}^{2} + {a}_{3} {T}^{3} + {a}_{4} {T}^{4} ;$$
$$\frac{h ( T )}{{R}_{u}} = {a}_{0} T + \frac{{a}_{1} {T}^{2}}{2} + \frac{{a}_{2} {T}^{3}}{3} + \frac{{a}_{3} {T}^{4}}{4} + \frac{{a}_{4} {T}^{5}}{5} + {a}_{5} ;$$
$$\frac{s ( T )}{{R}_{u}} = {a}_{0} {ln}^{T} + {a}_{1} T + \frac{{a}_{2} {T}^{2}}{2} + \frac{{a}_{3} {T}^{3}}{3} + \frac{{a}_{4} {T}^{4}}{4} + {a}_{6} ;$$
where, aᵢ is a coefficient of the index i in the polynomial, Cₚ is a constant pressure specific heat capacity, Rᵤ is a general gas constant, h is an enthalpy value, s is an entropy value, Tis temperature, a₀ is a polynomial coefficient velocity vector, and a₁, a₂, a₃, a₄, a₅ and a₆ are polynomial coefficients; and
a calculation formula for the Sutherland coefficient is:
$$μ = \frac{{A}_{s} \sqrt{T}}{1 + \frac{{T}_{s}}{T}} ;$$
where, μ is a dynamic gas viscosity, Aₛ and Tₛ are Sutherland coefficients, and T is the temperature.

6. The method of claim 1, wherein, in step 3, the three-dimensional combustion process equation is:
$$\frac{\partial ( ρ b )}{\partial t} + \frac{\partial ( ρ {\tilde{u}}_{i} b )}{\partial {x}_{i}} = \frac{\partial }{\partial {x}_{i}} ( \frac{{μ}_{t}}{S {c}_{t}} \cdot \frac{\partial b}{\partial {x}_{i}} ) - {\dot{ω}}_{b} ;$$
where, ρ is density, b is a combustion regression variable, ũᵢ is a velocity vector, μₜ is a dynamic viscosity under turbulent state, S_{ct} is a turbulent Schmidt number, \dot{ω}_{b·} is a reaction velocity source term, t is time, and xᵢ is displacement.

7. The method of claim 1, wherein, in step 3, a control equation for physical parameters in the three-dimensional combustion process equation includes:
a surface filtration strain rate control equation, a turbulence generation rate control equation, a turbulence removal rate control equation, and a decomposition strain rate control equation, wherein
the control equation for surface filtration strain rate is:
$${σ}_{s} = \frac{∇ \cdot {U}_{s} - \hat{n} \cdot ( ∇ {U}_{s} ) \cdot \hat{n}}{Ξ} + \frac{( Ξ + 1 ) ( ∇ \cdot ( {S}_{u} \hat{n} ) - \hat{n} \cdot ( ∇ \cdot ( {S}_{u} \hat{n} ) ) \cdot \hat{n} )}{2 Ξ} ;$$
where, σₛ is the surface filtration strain rate, Uₛ is a flame surface filtration rate, \hat{η} is a strain rate in propagation direction, Ξ is a flame subgrid fold factor;
the decomposition strain rate control equation is:
$${σ}_{t} = ∇ \cdot ( {U}_{s} + {S}_{u} Ξ \hat{n} ) - \hat{n} \cdot ( ∇ ( {U}_{s} + {S}_{u} Ξ \hat{n} ) ) \cdot \hat{n} ;$$
where, σₜ is a decomposition strain rate, Sᵤ is a laminar flame rate.

8. (canceled)

9. (canceled)
